(19) United States
(12) Patent Application Publication
(10) Pub. No.: US 2026/0233672 A1
(43) Pub. Date: Aug. 13, 2026

(54) TRAILER HITCH BALL AND COUPLER COMPATIBILITY DETECTION SYSTEM

(71) Applicant: Ford Global Technologies, LLC, Dearborn, MI (US)

(72) Inventors: Andrew B. Brown, Royal Oak, MI (US); Michael A. Mcnees, Flat Rock, MI (US); Brendan Diamond, Naples, FL (US); Matthew Penne, Pierce, NE (US); Keith Weston, Canton, MI (US)

(73) Assignee: Ford Global Technologies, LLC, Dearborn, MI (US)

(21) Appl. No.: 19/050,761

(22) Filed: Feb. 11, 2025

(51) Int. Cl. B60R 1/00; B60D 1/06; B60D 1/58

(52) U.S. Cl. CPC B60R 1/003; B60D 1/065; B60D 1/58

(57) ABSTRACT

A vehicle control system includes an imager mounted with and directed to an area to a rear of the vehicle and outputting image data, a detector mounted with and directed to the area to the rear of the vehicle and outputting proximity data, and a controller. The controller, responsive to identifying a hitch ball in the image data, determines a size of the hitch ball. The controller also receives at least one of the image data or proximity data and determines a size of a coupler of the trailer and determines a compatibility state of the hitch ball and the coupler based on the size of the hitch ball and the size of the trailer. Responsive to the size of the hitch ball and the size of the coupler of the trailer being determined to be incompatible, the controller causes a mismatch indication to be issued by the vehicle.

### FIELD OF THE DISCLOSURE

The present disclosure generally relates to a vehicle control system and, more particularly, a vehicle control system that detects a mismatch between a vehicle hitch ball and a trailer coupler before notifying the vehicle driver.

### BACKGROUND OF THE DISCLOSURE

In one common arrangement, trailers connect with a vehicle for towing by way of a coupler, positioned and rigidly fixed on the end of the trailer tongue, fitting over a hitch ball coupled with the vehicle. This connection allows multi-directional articulation of the trailer relative to the vehicle and is structured to maintain the desired connection of the trailer to the vehicle. Achieving a proper fit between the coupler and the hitch ball is, accordingly, desired to facilitate rotation of the coupler about the hitch ball. This facilitates articulation of the trailer with respect to the vehicle, while providing for proper latching of the coupler onto the hitch ball. To facilitate this fit, trailer couplers and balls come in multiple industry-standard sizes that mutually correspond to achieve desired fitment. In one aspect, it is noted that trailer couplers will fit over a trailer ball that is too small, however it will not be securely latched. Further, a user may have multiple trailers with different size couplers, which may generally correspond in size with the size and weight capacity of the trailer and will, accordingly, possess multiple hitch ball units to correspond with such an array of trailers.

### SUMMARY OF THE DISCLOSURE

According to one aspect of the present disclosure, a vehicle control system includes an imager mounted with and directed to an area to a rear of the vehicle and outputting image data, a detector mounted with and directed to the area to the rear of the vehicle and outputting proximity data, and a controller. The controller receives the image data and, responsive to identifying a hitch ball in the image data, determines a size of the hitch ball. The controller also receives at least one of the image data or proximity data and determines a size of a coupler of the trailer and determines a compatibility state of the hitch ball and the coupler based on the size of the hitch ball and the size of the trailer. Responsive to the size of the hitch ball and the size of the coupler of the trailer being determined to be incompatible, the controller causes a mismatch indication to be issued by the vehicle.

Embodiments of the first aspect of the invention can include any one or a combination of the following features:
The imager can include a video camera having a resolution of at least 3840 pixels by 2160 pixels.
The video camera can be mounted to the rear of the vehicle and directed to a hitch ball location on the rear of the vehicle.
The controller can determine the size of the hitch ball by further identifying a marking on the hitch ball indicating the size of the hitch ball and analyzing the marking using an optical character recognition process.
The controller can determine the size of the hitch ball by measuring the identified hitch ball in the image data.
The vehicle control system can further include a human machine interface including at least one of a video screen and a speaker, and the controller can cause the mismatch indication to be issued by the vehicle by way of the at least one of the video screen or the speaker.
Each of the size of the hitch ball and the coupler can be identified as corresponding with at least one of a known size or a known type stored in a database.
The detector can include at least one of a LiDAR unit, a Radar unit, or an ultrasonic sensor.
The controller can further monitor the image data to determine if a trailer is present within the area to the rear of the vehicle and, responsive to identifying a trailer in the area to the rear of the vehicle, can determine the size of the coupler of the trailer identified in the area to the rear of the vehicle using the proximity data.
The controller can determine the size of the coupler based on a portion of the proximity data corresponding with a location of the coupler of the trailer in the image data.
The controller can determine the size of the coupler by using the proximity data to determine a distance between the coupler of the trailer and the vehicle and using the distance between the coupler of the trailer and the vehicle as a reference, measuring the coupler of the trailer in the image data.

According to another aspect of the present disclosure, a vehicle control system, includes a human machine interface positionable within the vehicle, a vehicle brake system, a vehicle powertrain system, and a controller in communication with the vehicle brake system and configured to control a service brake included in the vehicle brake system. The controller is further in communication with the vehicle powertrain system and is configured to control a throttle included in the powertrain system. The controller executes a hitching confirmation process, including causing the vehicle to move forward by control of the throttle, subsequently causing the vehicle to stop by control of the service brakes, and monitoring for relative motion of a coupler of a trailer connected with a hitch ball of the vehicle above a predetermined threshold. Responsive to detecting relative motion of the coupler and the hitch ball above the predetermined threshold, the controller causes a mismatch indication to be issued by the vehicle via the human machine interface.

According to another aspect of the present disclosure, a method for controlling a vehicle includes processing high-definition image data obtained from a high-resolution camera mounted on a rear of the vehicle using at least one of a trained machine learning model or an optical character recognition routine to determine a size of a hitch ball connected with the vehicle and identified in the image data and processing at least one of the high-definition image data or sensor data received from a sensor mounted to the vehicle to determine a size of a trailer coupler spaced from the vehicle and identified in the image data. The method further includes determining a compatibility state of the hitch ball and the coupler based on the size of the hitch ball and the size of the trailer and, responsive to the size of the hitch ball and the size of the coupler of the trailer being determined to be incompatible, causing a mismatch indication to be issued by the vehicle.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a trailer coupler connected with a vehicle hitch ball;

FIG. 2 is an assembly view of the coupler positioned for connection with the hitch ball;

FIG. 3 is a cross-section view of a hitch ball received in a proper fit with a corresponding hitch ball;

FIG. 4 is a cross-section view of a hitch ball received in a mis-matched fit with a coupler.

FIG. 5 is a perspective view of a vehicle positioned for alignment with a trailer in a hitching maneuver.

FIG. 6 is a schematic view of a vehicle control system according to the present disclosure;

FIG. 7 is a sample view of image data obtainable from a tailgate camera of a vehicle showing an assembled hitch ball.

FIG. 8 is a sample view of image data obtainable from a dedicated hitch ball camera of a vehicle showing the assembled hitch ball.

FIG. 9 is a flowchart showing a coupler and hitch ball fit assessment process according to an aspect of the disclosure; and

FIG. 10 is a cross section view showing relative movement of a coupler relative to a mis-matched hitch ball.

### DETAILED DESCRIPTION OF THE PREFERRED EMBODIMENTS

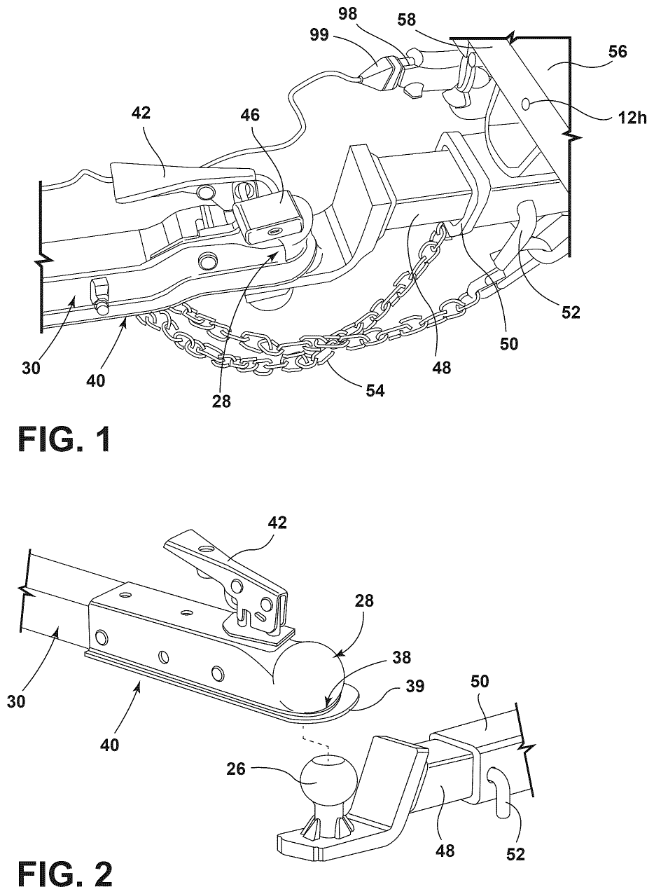

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

Ordinal modifiers (i.e., “first”, “second”, etc.) may be used to distinguish between various structures of the disclosed vehicle control system in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

Referring to FIGS. 1-10, reference numeral 10 generally designates a vehicle control system. The control system 10 includes an imager 12 mounted with and directed to an area to a rear 14 of the vehicle 16 and outputting image data 18, a detector 20 mounted with and directed to the area to the rear 14 of the vehicle 16 and outputting proximity data 22, and a controller 24. The controller 24 receives the image data 18 and, responsive to identifying a hitch ball 26 in the image data 18, determines a size of the hitch ball 26. The controller 24 also receives at least one of the image data 18 or proximity data 22 and determines a size of a coupler 28 of a trailer 30 and determines a compatibility state of the hitch ball 26 and the coupler 28 based on the size of the hitch ball 26 and the size of the coupler 28. Responsive to the size of the hitch ball 26 and the size of the coupler 28 of the trailer 30 being determined to be incompatible, the controller 24 causes a mismatch indication 32 to be issued by the vehicle 16.

As shown in FIGS. 1-5, a trailer 30 may, in one possible arrangement, be connected with a vehicle 16 for towing by way of the aforementioned coupler 28 being connected with the hitch ball 26. In this arrangement, the coupler is rigidly coupled on the forward end 40 of the tongue 34 of the trailer 30. More specifically, as shown in FIGS. 1 and 2, the coupler 28 is typically formed of a stamped piece of metal sheet material (e.g., steel or the like) that is connectable with the particular trailer 30 with which it is assembled (for example, using rigid fasteners, including bolts, rivets, or the like). The coupler 28 is further shaped to define a cavity 36 that is at least partially spherical in shape and defines an undercut 38 along at least a forward end 39 thereof, but not fully encircling the cavity 36. In this manner, the coupler 28 can receive the hitch ball 26 therein by being vertically lowered onto the hitch ball 26, which is similarly generally spherical, along at least a portion thereof. As further shown, the coupler 28 further includes a latch 42 that controls fore and aft movement of a block 44 such that the latch 42 can allow for assembly of the coupler 28 onto the hitch ball 26 when the latch 42 is rotated into an upward, release position, in which the block 44 is disposed in the rearward position, when the hitch ball 26 is received within the cavity 36, the latch 42 can be lowered and secured (e.g., using a lock 46) to maintain the block 44 in the forward position. When in this position, the hitch ball 26 is maintained toward the forward end 39 of the cavity 36, with the undercut 38 extending beneath a portion of the hitch ball 26 such that the hitch ball 26 is retained with the cavity 36 during vehicle movement, maintaining the connection between the coupler 28 and the hitch ball 26, and accordingly, the trailer 30 with the vehicle 16. As further shown, the hitch ball 26 is rigidly mounted to a shank 48 that is assembleable within a receiver 50 that is rigidly fixed with the vehicle 16 and securable by way of a pin 52 of the like. A set of chains 54 can be assembled between the trailer 30 and the vehicle 16 as an additional measure.

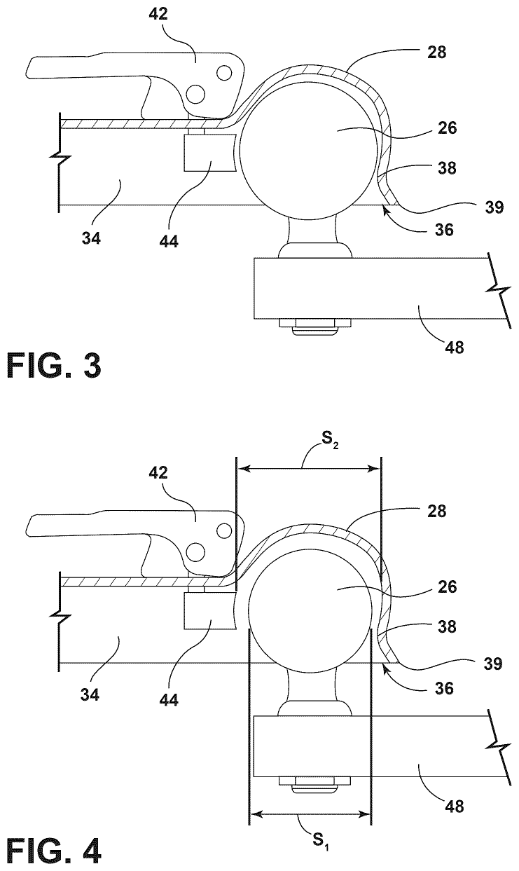

As can be appreciated, a proper fit between the coupler 28 and the hitch ball 26 is desired to both facilitate rotation of the coupler 28 about the hitch ball 26 (to facilitate articulation of the trailer 30 with respect to the vehicle 16), while providing for proper latching of the coupler 28 onto the hitch ball 26, as discussed above, an example of which is shown in FIG. 3. To facilitate this fit, trailer couplers and balls come in multiple industry-standard sizes that mutually correspond to achieve desired fitment. In one aspect, it is noted that trailer couplers will fit over a trailer ball that is too small, however it will not be securely latched (i.e., by way of a distance) between the block 44 and the undercut 38 being greater than a diameter of the hitch ball 26, as shown in the example of FIG. 4. As can be appreciated, a user may have multiple trailers with different size couplers 28 (as the coupler size may generally correspond with the size and weight capacity of the trailer 30) and will, accordingly, possess multiple hitch ball 26 units to correspond with such an array of trailers 30. Accordingly, the present system 10 is configured to check for a match between the vehicle hitch ball 26 and the identified trailer 30. In one aspect, this can occur during a hitching operation, wherein the driver, or an automated system, is backing the vehicle 16 toward the trailer 30 for connection therewith. an example of such an automated system is disclosed in U.S. Pat. App. Pub. No. 2021/0347410.

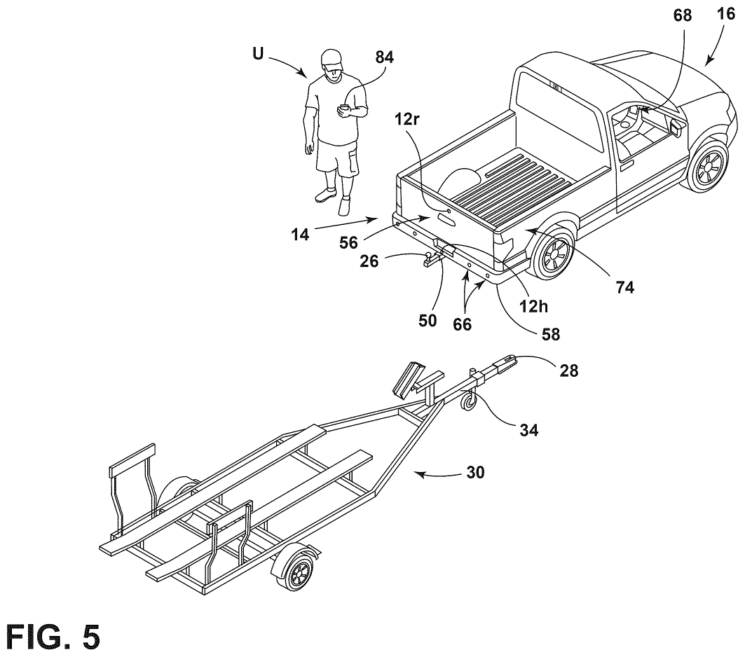

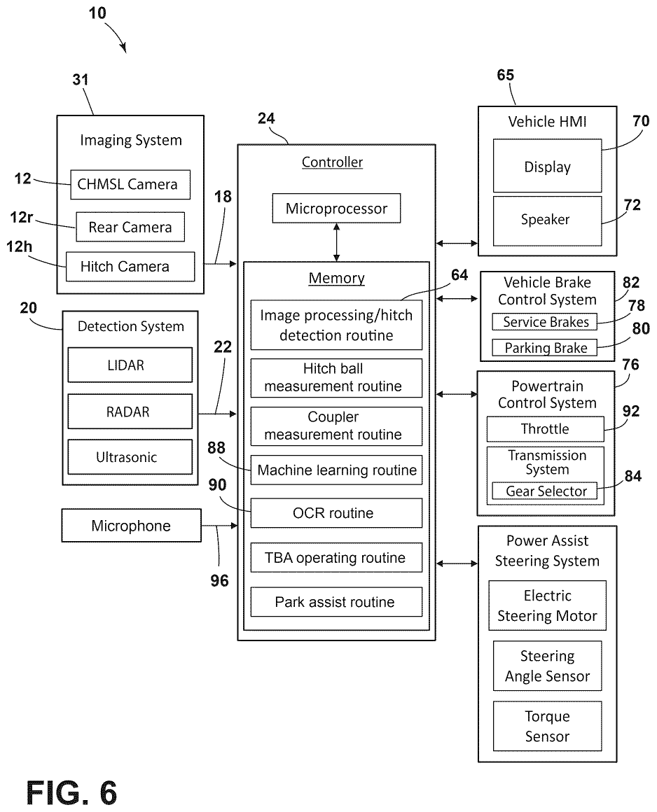

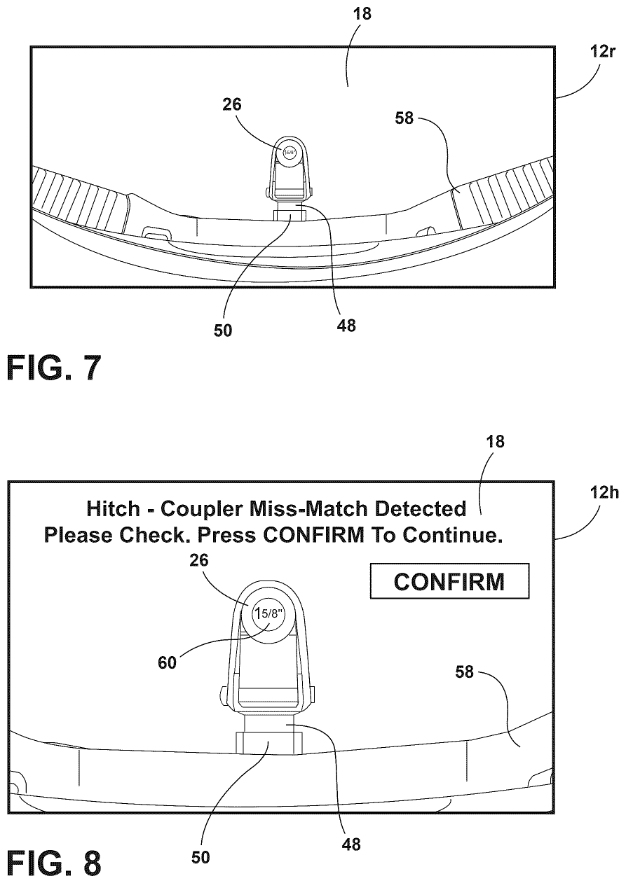

As shown in FIG. 6, the above-mentioned imager 12 can be included in an imaging system 31 of the vehicle 16. In a particular arrangement, the imager 12 can be a video camera and the imaging system 31 can further include having multiple imagers in the form of a set of digital video cameras 12. In an example, a vehicle imaging system 31 can include a rear camera 12r (among various other cameras in various possible configurations and arrangements) that is mounted on a tailgate 56 of the depicted vehicle 16 and used allow the user to see a wide portion of the area to the rear 14 of the vehicle 16, an example view of which is shown in FIG. 7. In one aspect, the present system 10 can leverage the rear camera 12r to determine the size S1 of the hitch ball 26. In this respect, it is noted that wide-angle digital video cameras typically used for rear vehicle cameras 12r may not have a sufficient resolution to accurately visualize the hitch ball 26 to determine its size S1 by at least some of the various processes discussed herein. This may be the case even when a high-definition (HD) camera is used, as such cameras typically have a resolution of 1920×1080 pixels, also known as 1080p, providing about 2.1 megapixels. To provide the accuracy needed for some of the measurement processes discussed herein, the rear camera 12r can be a video camera with a resolution of at least 3840 pixels by 2160 pixels, equating to about 8.3 megapixels, which may be known as an ultra-high-definition (UHD) camera or a 4K camera. There are also 8K cameras with a resolution of 7680×4320 pixels, offering even higher detail, which may also be used for rear camera 12r. Additionally or alternatively, the imaging system 31 can include a dedicated hitch ball camera 12h that is mounted to the rear 14 of the vehicle 16 and directed to the hitch ball 26 location on the rear 14 of the vehicle 16, an example view from which is shown in the example of FIG. 8. As also shown in FIG. 5, the hitch ball camera 12h can be mounted to the bumper 58 of the vehicle so as to be in close proximity to the hitch ball 26, when installed on the vehicle 16. The use of such a camera may allow for accurate measurement with a lower resolution, such as HD resolution, although a higher resolution camera can be used.

In one example, the controller 24 can determine the size S1 of the hitch ball 26 by identifying a marking 60 on the hitch ball 26 (FIG. 8), with such markings 60 typically being included on vehicle hitch balls 26 to indicate its size. In this respect, the controller 24 can analyze the image data 18 to identify the text included in the marking 60 using an optical character recognition (“OCR”) process. In one example, by using trained machine learning models, the controller 24 can recognize different types and sizes of couplers 24 (e.g., 1-⅞″, 2″, 2- 5/16″, 3″, etc.) based the image data 18 to effectively “read” the size marking 60 that is etched or stamped onto the trailer ball. Various image processing methods can be used for this OCR to produce a high degree of accuracy. Additionally or alternatively, the controller 24 can determine the hitch ball 26 size S1 via image processing, such as edge detection and/or various machine learning processes to identify the hitch ball 26 within the image data 18, with a pixel count process, for example, being used to determine the hitch ball 26 size S1, including by optionally calibrating the pixel count calculation based on comparison with an additional object of a known size (such as a factory marking or other original feature(s)) of the vehicle 16 within the field of view of the utilized camera 12.

As discussed above, the size S1 of the hitch ball 26 is determined to evaluate a fit between the hitch ball 26 and a nearby coupler 28 prior to an attempt to connect the two features together, such that the controller 24 will also look to determine the size S2 of a nearby trailer 30. In one aspect, the controller 24, during or subsequent to the hitch ball 26 size S1 determination discussed above, can further monitor the image data 18 to determine if a trailer 30 is present within the area to the rear 14 of the vehicle 16 (as shown, for example, in FIG. 5). This can be done using various image recognition techniques, including but not limited to edge detection algorithms and/or various machine learning techniques. If a trailer 30 is identified, the controller 24 can determine the size S2 of the coupler 28. In one implementation, this may be done using the image data 18, including the image data 18 received from the rear camera 12r, when the resolution of the camera is sufficiently high to determine the size of the coupler 28. In one aspect, the trailer may be identifiable using a machine learning process trained on a database of different known trailers, including, but not limited to, identification of a particular marking (such as the trailer manufacturer name and/or model number of the trailer) and/or the image data 18 including a sufficient portion of the trailer itself. If the trailer 30 can be successfully identified using this technique, the associated database entry can also include the size S2 of the coupler 28 that is included on the trailer 30 by the manufacturer such that the size S2 of the coupler is then known. In a further variation, the image data 18 can be further analyzed to determine the distance between the hitch ball 26 and the coupler 28, such that the coupler 28 can be specifically identified in the image data 18 and measured using a pixel count algorithm, calibrated based on the distance of the coupler 28 from the hitch ball 26, to determine the size S2 thereof. The system can look up coupler size based on trailer image identification and/or OCR interpretation, utilizing image recognition of specific trailer models to access as-built trailer specifications via the internet or a pre-loaded database. The user can be asked to confirm the optically determined sizing.

In another implementation, the size S2 of the coupler 28 can be determined using the proximity data 22 received from the detector 20. As shown in FIGS. 5 and 6, the detector 20 can consist of a detection system 20 and can include at least one of a LiDAR unit 62, a radar unit 64, or an ultrasonic sensor 66, all of which output their own proximity data 22, including with specific point location data of detected objects surrounding the vehicle 16. The controller 24 can use any, or a combination of, the available proximity data 22 to measure the distance Dc between the coupler 28 and the hitch ball 26 (or vehicle 16) and can, further, determine the size S2 of the coupler 28 based on the point location data within the proximity data 22. This can be done after first identifying the coupler 28 in the image data 18 and correlating the identified location of the coupler 28 with the object point location data to confirm the correct data for such measurement. Additionally, the measurement achieved using the image data 18, proximity data 22, or both, can be compared against a database of known coupler sizes to identify or confirm the correct one based on the closest match to the measured size S2. The respective sizes S1, S2 of the hitch ball 26 and the coupler 28 can be identified as corresponding with a least one known size stored in a database and a corresponding association (e.g., a mutual fit) therebetween to determine if the measured size S1 of the hitch ball 26 fits with the measured size S2 of the coupler 28.

As further shown in FIGS. 5 and 6, the vehicle control system 10 can further include a human machine interface (“HMI”) 68 with at least one of a video screen 70 and a speaker 72. In the event that the controller 24 determines that the size S1 of the hitch ball 26 does not match with the size S2 of the coupler 28, the controller 24 can cause the above-mentioned mismatch indication 32 to be issued by the vehicle 16 through the video screen 70 and/or the speaker 72. In one aspect, the speaker 72 can be a vehicle exterior speaker or can be in the form of a panel exciter operably coupled with one of the vehicle panels 74. In one aspect, the controller 24 can present the mismatch indication 32 if there is a detected mismatch between the hitch ball 26 and coupler 28 size S1, S2 during an identified hitching process (e.g., if it is determined that the vehicle is moving in reverse toward an identified trailer 30 or if the controller 24 is executing an automated hitching process) via the HMI 68. In a further aspect, the controller 24 could prevent movement of the vehicle 16, after stopping at the end of the identified hitching maneuver, if a mismatch is identified, until the operator manually overrides or acknowledges the size mismatch detection, for example by restricting operation of the vehicle powertrain system 76 or maintaining the vehicle service brakes 76 or parking brake 78 in an engaged position by control of the vehicle brake system 82. If the measured size S2 of the coupler 28 is larger than the measured size S1 of the hitch ball 26 by above a predetermined threshold, the controller 24 can prompt that the user U visually check underneath the coupler 28. This check can be augmented by leveraging a smartphone 84, or another measuring device, particularly via mirroring or an extension of the HMI 68 via a smartphone app that can facilitate communication of the smartphone 84 with the HMI 68 by Bluetooth, WiFi, or the like. The HMI 68 can further cause the vehicle 16 to announce the size S1 of the hitch ball 26 to the user and request confirmation that the coupler 28 is of the appropriate size, including if the controller 24 cannot determine the size S1 or S2 of one or more of the hitch ball 26 or coupler 28 between two possible sizes, for example. This can be done, as discussed above, using the speaker 72 (including by way of panel 74) or by a connected smartphone 84.

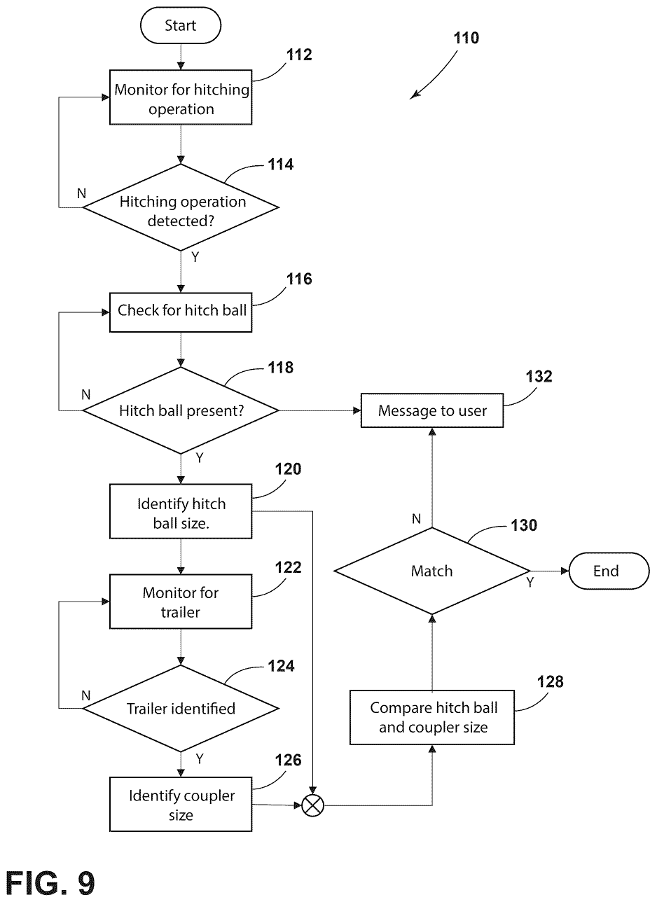

Turning to FIG. 9, a method 110 for controlling a vehicle, such as vehicle 16, as discussed above in connection with FIG. 5, is schematically shown. In one aspect, the method 110 includes initially, optionally monitoring for a hitch operation (step 112), which can be done by monitoring the image data 18 for a nearby trailer 30 detected within the image data 18 and, further optionally, by monitoring the powertrain system 76 for an indication that the vehicle gear selector 86 is in reverse. If a hitching operation is detected (if checked, step 114), the controller 24 can then check for a hitch ball 26 within the image data 18 (step 116). When a hitch ball 26 is identified (step 118), the controller 24 can process the image data 18, including high-definition image data 18 obtained from a high-resolution camera 12r or 12h using a trained machine learning model 88 or an OCR routine 90 (FIG. 6) to determine the size S1 of the hitch ball 26 (step 120). As discussed above, the hitch ball 26 can include a size marking 60 on an exterior surface (e.g., a flat upper surface 61 thereof). The optical character recognition routine 90 can identify the size marking 60 and recognize at least one numeric character within the size marking 60. The determination of the size S1 of the hitch ball 26 can be based on a numeric assessment of the at least one numeric character within the size marking. In a further, optional, step (122), the controller 24 can notify the user if the hitch ball 26 is detected.

The method 110 also includes determining the size S2 of an identified trailer coupler 28 (step 124). In one example, the controller 24 can seek to identify a trailer 30 and/or the coupler 28 of an associated trailer 30 within the image data 18 (which may be done as a part of the hitching operation detection in optional step 112) or otherwise obtain confirmation that a trailer 30 is nearby and determine at least a rough location of the coupler 28 (step 126). When a coupler 28 is identified, the size S2 is determined, which may be done by processing the high-definition image data 18 or proximity data 22 received from the rear camera 12r (in a variation with suitable resolution) or one of the devices in the detection system 20 to determine the size S2 of the coupler 28 identified in the image data 18, according to any of the above-described processes. The method further includes determining the compatibility state of the hitch ball 26 and the coupler 28 based on their sizes (step 128), and if they are determined to be incompatible (step 130), issuing a mismatch indication 32 by the vehicle (132). As discussed above, the method can further include restricting vehicle movement and seeking fit or correction confirmation from the user.

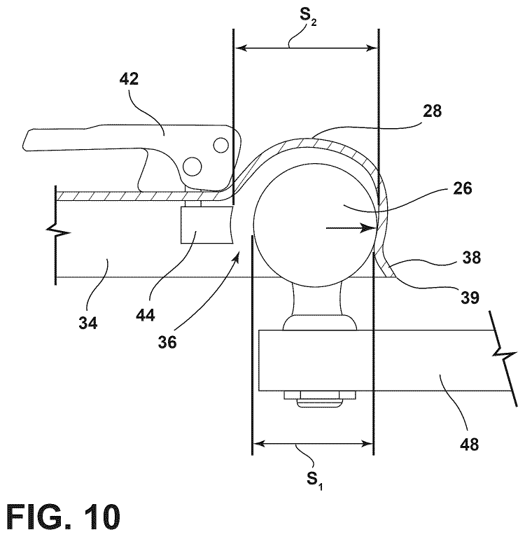

In a variation of the vehicle control system 10, discussed above, the system includes HMI 68 within the vehicle 16, vehicle brake system 82, vehicle powertrain system 76, and controller 24. As shown in FIG. 6, the controller 24 is in communication with the vehicle brake system 82 and configured to control service brakes 78 included in the vehicle brake system 82. The controller 24 is further in communication with the vehicle powertrain system 76 and is configured to control a throttle 92 included in the powertrain system 76. The controller 24 executes a hitching confirmation process that includes causing the vehicle 16 to move forward by controlling the throttle 92 and/or the service brakes 78. After achieving a desired amount of movement, the controller 24 subsequently causes the vehicle 16 to stop by controlling the service brakes 78 (and, if needed, the throttle 92). The controller 24 then monitors for relative motion of the coupler 28 of trailer 30 connected with hitch ball 26 of the vehicle 16 above a predetermined threshold. Responsive to detecting relative motion of the coupler 28 and the hitch ball 26 above the predetermined threshold, the controller 24 causes the mismatch indication 32 to be issued by the vehicle 16 via the HMI 68. Notably, as shown in FIGS. 4 and 10, if the coupler 28 that is assembled with the hitch ball 26 is too large, the coupler 28 (along with the trailer) will move relative to the hitch ball 26 (and vehicle 16) by an amount larger than that attributable to the typical coupler 28 and hitch ball 26 tolerance. In this manner, the controller 24, as discussed above, executes an automated vehicle 16 maneuver to drive forward or backward a small distance, while monitoring one or a combination of known factors that relate to the coupler 28 to hitch ball 26 fit. In one implementation, during the above-described maneuver, the controller 24 can command the trailer 30 to apply and hold a trailer brake. The controller 24 can then monitor for excessive relative motion between the vehicle 16 and trailer 30, of which there should be very little, since trailer motion is restrained.

In another aspect, the powertrain system 76 may include one or more electric motors (such as in the case of a battery electric vehicle or a hybrid vehicle). Position control in electric motors may be precise enough to move the vehicle forward by millimeters. If the coupler 28 is too large for the hitch ball 26, position control will slightly move the vehicle 16 forward with smaller torque until the slack between the oversized coupler 28 and the hitch ball 26 (initially shown in FIG. 4) is taken up (by contact of the hitch ball 26 with the front end of the coupler 28, as shown in FIG. 10). Once the distance is taken up, the electric motor(s) will require larger torque and current to continue to move the vehicle 16 forward, even slightly. A series of maneuvers, slightly forward and reverse on the scale of 0.5-2 inches, would allow the electric motors to know if the coupler 28 is oversized based on the necessary torque to inch forward rapidly increasing.

In addition to any detectable change in torque, the above-mentioned factors relating to a coupler 28 and hitch ball 26 size S1, S2, mis-match can include the trailer 30 to vehicle 16 relative velocity or motion difference. In another example, the movement of the coupler 28 relative (or into) the hitch ball 26 may produce an audible indicator. Accordingly, the vehicle control system 10 can further include a microphone 94 configured for detecting sound exterior to the vehicle 16 and outputting audio data 96. The controller 24 can receive the audio data 96 from the microphone 94 and detect relative motion of the coupler 28 and the hitch ball 26 above the predetermined threshold by detection of a portion of the audio data 96, including audible contact between an interior of the coupler 28 and the hitch ball 26 above a predetermined decibel level or otherwise matching a predetermined audio profile. A brake torque sensor can also be used to monitor for a delayed increase in brake torque due to delayed contact between the hitch ball 26 and coupler 28 due to a size S1, S2, mis-match. In further aspects, the vehicle control system 10 can further include a vibration sensor operably coupled with the hitch ball 26 and outputting vibration data. The controller 24 can receive the vibration data from the vibration sensor to detect relative motion of the coupler and the hitch ball above the predetermined threshold by detection of a portion of the vibration data indicating contact between an interior of the coupler 28 and the hitch ball 26. Alternatively, detecting high vibration at low speed can indicate that there is a size mis-match. The vehicle control system 10 can further leverage the imager 12, such as the hitch ball camera 12h, by identifying the coupler 28 in the image data 18 and comparing the location of the coupler 28 to a fixed portion of the vehicle 16 in the image data 18 to detect relative motion of the coupler 28 and the hitch ball 26 above the predetermined threshold by monitoring the position of the coupler 28 in the image data 18 for movement toward or away from the fixed portion of the vehicle 16. In a further aspect, the vehicle control system 10 can monitor the trailer electrical coupling 98 (FIG. 1) connected with the vehicle 16 for connection with a trailer connector 99 prior to executing a hitching confirmation process according to the above descriptions, such that the controller 24 initiates such a check when a trailer 30 has been newly connected with the vehicle 16. The controller 24, upon detecting a mis-match according to any or multiple of the above-described processes, can take any of the measures discussed above.

In yet a further aspect, trailers 30 could be equipped with ultra-wide band (“UWB”) or RFID tags that contain information about the coupler 28 size S2. The controller 24 could then read a nearby tag as the coupler 28 approaches the hitch ball 26, identifying the size automatically.

It is to be understood that variations and modifications can be made on the aforementioned structure without departing from the concepts of the present disclosure, and further it is to be understood that such concepts are intended to be covered by the following claims, unless these claims by their language expressly state otherwise.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A vehicle control system, comprising:
an imager mounted with and directed to an area to a rear of a vehicle and outputting image data;
a detector mounted with and directed to the area to the rear of the vehicle and outputting proximity data; and
a controller:
receiving the image data, and, responsive to identifying a hitch ball in the image data, determining a size of the hitch ball;
receiving at least one of the image data or proximity data and determining a size of a coupler of a trailer;
determining a compatibility state of the hitch ball and the coupler based on the size of the hitch ball and the size of the coupler of the trailer; and
responsive to the size of the hitch ball and the size of the coupler of the trailer being determined to be incompatible, causing a mismatch indication to be issued by the vehicle.

2. The vehicle control system of claim 1, wherein the imager includes a video camera has a resolution of at least 3840 pixels by 2160 pixels.

3. The vehicle control system of claim 2, wherein the video camera mounted to the rear of the vehicle and directed to a hitch ball location on the rear of the vehicle.

4. The vehicle control system of claim 1, wherein the detector includes at least one of a LiDAR unit, a Radar unit, or an ultrasonic sensor.

5. The vehicle control system of claim 4, wherein:
the controller further monitors the image data to determine if the trailer is present within the area to the rear of the vehicle; and
responsive to identifying the trailer in the area to the rear of the vehicle, determining the size of the coupler of the trailer identified in the area to the rear of the vehicle using the proximity data.

6. The vehicle control system of claim 5, wherein the controller determines the size of the coupler based on a portion of the proximity data corresponding with a location of the coupler of the trailer in the image data.

7. The vehicle control system of claim 5, wherein the controller determines the size of the coupler by:
using the proximity data to determine a distance between the coupler of the trailer and the vehicle; and
using the distance between the coupler of the trailer and the vehicle as a reference, measuring the coupler of the trailer in the image data.

8. The vehicle control system of claim 1, wherein the controller determines the size of the hitch ball by further identifying a marking on the hitch ball indicating the size of the hitch ball and analyzing the marking using an optical character recognition process.

9. The vehicle control system of claim 1, wherein the controller determines the size of the hitch ball by measuring the identified hitch ball in the image data.

10. The vehicle control system of claim 1, further including a human machine interface including at least one of a video screen and a speaker, wherein:
the controller causes the mismatch indication to be issued by the vehicle by way of the at least one of the video screen or the speaker.

11. The vehicle control system of claim 1, wherein each of the size of the hitch ball and the coupler is identified as corresponding with at least one of a known size or a known type stored in a database.

12. A control system for a vehicle, comprising:
a human machine interface positionable within the vehicle;
a vehicle brake system;
a vehicle powertrain system; and
a controller:
in communication with the vehicle brake system and configured to control a service brake included in the vehicle brake system;
in communication with the vehicle powertrain system and configured to control a throttle included in the powertrain system;
executing a hitching confirmation process, including causing the vehicle to move forward by control of the throttle, subsequently causing the vehicle to stop by control of the service brakes, and monitoring for relative motion of a coupler of a trailer connected with a hitch ball of the vehicle above a predetermined threshold; and
responsive to detecting relative motion of the coupler and the hitch ball above the predetermined threshold, causing a mismatch indication to be issued by the vehicle via the human machine interface.

13. The vehicle control system of claim 12, further including a microphone configured for detecting sound exterior to the vehicle and outputting audio data, wherein:
the controller receives the audio data from the microphone and detecting relative motion of the coupler and the hitch ball above the predetermined threshold by detection of a portion of the audio data including audible contact between an interior of the coupler and the hitch ball.

14. The vehicle control system of claim 12, further including a vibration sensor operably coupled with the hitch ball and outputting vibration data, wherein:
the controller receives the vibration data from the vibration sensor and detects relative motion of the coupler and the hitch ball above the predetermined threshold by detection of a portion of the vibration data indicating contact between an interior of the coupler and the hitch ball.

15. The vehicle control system of claim 12, further including an imager mounted with and directed to an area to a rear of the vehicle and outputting image data, wherein:
the controller receives the image data, identifies the coupler and a fixed portion of the vehicle in the image data, and detects relative motion of the coupler and the hitch ball above the predetermined threshold by monitoring a position of the coupler in the image data for movement toward the fixed portion of the vehicle.

16. The vehicle control system of claim 12, wherein the controller, responsive to detecting relative motion of the coupler and the hitch ball above the predetermined threshold, further retains the service brakes in an activated condition.

17. The vehicle control system of claim 12, further including a trailer electrical coupling connected with the vehicle and in communication with the controller, wherein:
the controller monitors the trailer electrical coupling for connection with a trailer connector prior to executing a hitching confirmation process.

18. A method for controlling a vehicle, comprising:
processing high-definition image data obtained from a high-resolution camera mounted on a rear of the vehicle using at least one of a trained machine learning model or an optical character recognition routine to determine a size of a hitch ball connected with the vehicle and identified in the image data;
processing at least one of the high-definition image data or sensor data received from a sensor mounted to the vehicle to determine a size of a trailer coupler spaced from the vehicle and identified in the image data;
determining a compatibility state of the hitch ball and the coupler based on the size of the hitch ball and the size of the coupler of the trailer; and
responsive to the size of the hitch ball and the size of the coupler of the trailer being determined to be incompatible, causing a mismatch indication to be issued by the vehicle.

19. The method of claim 18, wherein:
the hitch ball includes a size marking on an exterior surface thereof;
the optical character recognition routine identifies the size marking and recognizes at least one numeric character within the size marking; and
the determination of the size of the hitch ball is based on a numeric assessment of the at least one numeric character within the size marking.

20. The method of claim 18, wherein the determination of the size of the coupler includes identifying a specific model of the trailer based on information included in the image data and obtaining the size of the coupler from a database entry corresponding with the specific model of the trailer.
